(19) United States
(12) Patent Application Publication
(10) Pub. No.: US 2015/0245290 A1
(43) Pub. Date: Aug. 27, 2015

(54) NODE CONTROL METHOD, NETWORK CONTROLLER, AND NETWORK SYSTEM

(71) Applicant: Huawei Technologies Co., Ltd., Shenzhen (CN)

(72) Inventor: Pei Liu, Beijing (CN)

(21) Appl. No.: 14/709,183

(22) Filed: May 11, 2015

Related U.S. Application Data
(63) Continuation of application No. PCT/CN2013/086951, filed on Nov. 12, 2013.

(30) Foreign Application Priority Data
Nov. 12, 2012 (CN) 201210449224.1

(51) Int. Cl. H04W 52/02; H04W 40/24

(52) U.S. Cl. CPC H04W 52/0216; H04W 52/0219; H04W 40/244

(57) ABSTRACT

Embodiments of the present invention provide a node control method, a network controller, and a network system. The node control method includes: constructing a wake-up frame, where the wake-up frame includes wake-up indication information of a node to be woken up; and sending, in an inactive period of a superframe structure, the wake-up frame according to preset sending time, so that a node that obtains, by listening, the wake-up frame performs data exchange with a network controller when it is determined, according to the wake-up indication information, that the node that obtains, by listening, the wake-up frame is the node to be woken up. A wake-up frame may be sent in an inactive period of a superframe structure to implement data communication between a node and a network controller, which increases a length of the superframe structure and can meet a requirement for data uploading by the node.

### CROSS-REFERENCE TO RELATED APPLICATIONS

This application is a continuation of International Application No. PCT/CN2013/086951, filed on Nov. 12, 2013, which claims priority to Chinese Patent Application No. 201210449224.1, filed on Nov. 12, 2012, both of which are hereby incorporated by reference in their entireties.

### TECHNICAL FIELD

Embodiments of the present invention relate to network technologies, and in particular, to a node control method, a network controller, and a network system.

### BACKGROUND

In a wireless sensor network, a node is generally powered by a built-in power supply; because energy of the built-in power supply is limited, energy consumption of the node in the network needs to be managed or controlled, so as to extend a life cycle of the node and the entire network. In energy consumption management of a network node, the node is generally controlled in a periodic wake-up mode.

In the prior art, a node control method using a superframe mechanism is proposed for low-rate wireless personal area networks. This method uses a superframe structure to perform node control. A network controller periodically broadcasts a beacon frame to nodes in a network according to a length of the superframe structure, and the nodes in the network also periodically wake up and receive the beacon frame according to the length of the superframe structure, and may establish communication with the network controller according to the received beacon frame and the superframe structure. The superframe structure is divided into two parts, namely, an active period and an inactive period. In the active period, the nodes in the network wake up and communicate with the network controller, and in the inactive period, the nodes in the network are in a sleep state, so as to save power. The active period includes a beacon frame sending period, a contention access period (CAP) and a contention free period (CFP). In the beacon frame sending period, the network controller may broadcast a beacon frame to synchronize the nodes in the network, and the nodes wake up in this period to receive and parse the beacon frame; in the contention access period, when the nodes determine, according to content of the beacon frame, to exchange data with the network controller, the nodes may acquire a channel for communication with the network controller; and in the contention free period, the nodes transmit data on the acquired channel.

However, when the nodes are controlled by using the existing superframe structure, because the active period of the superframe structure is relatively short, some nodes need to wait until a next superframe to upload data, thereby leading to data upload delay. Therefore, to avoid the data upload delay of the nodes, generally, the length of the existing superframe structure in use (namely, a broadcast cycle of a beacon frame) is relatively short, and the nodes in the network need to wake up frequently according to the relatively short period to receive and parse the beacon frame; consequently, power consumption of the nodes in the entire network is relatively large and a life cycle of the entire network is relatively short.

### SUMMARY

Embodiments of the present invention provide a node control method, a network controller, and a network system, which can solve a problem in existing node control that energy consumption is relatively large for nodes in the entire network.

According to a first aspect, an embodiment of the present invention provides a node control method, including:

constructing a wake-up frame, where the wake-up frame includes wake-up indication information of a node to be woken up; and

sending, in an inactive period of a superframe structure, the wake-up frame according to preset sending time, so that a node that obtains, by listening, the wake-up frame performs data exchange with a network controller when it is determined, according to the wake-up indication information, that the node that obtains, by listening, the wake-up frame is the node to be woken up.

With reference to the first aspect, in a first possible implementation manner, the wake-up indication information is anode address of the node to be woken up or a broadcast wake-up address, and the broadcast wake-up address is indication information used to wake up one type of node or all nodes.

With reference to the first aspect, in a second possible implementation manner, the number of the nodes to be woken up is one or more.

With reference to the first aspect, in a third possible implementation manner, the number of the wake-up frames is one or more.

With reference to the first aspect, in a fourth possible implementation manner, the wake-up frame further includes an address of the network controller.

With reference to the first aspect or the first or the second or the third or the fourth possible implementation manner of the first aspect, in a fifth possible implementation manner, the constructing a wake-up frame specifically includes:

constructing the wake-up frame according to preset listening time of the node to be woken up.

According to a second aspect, an embodiment of the present invention provides a node control method, including:

listening, at preset listening time in an inactive period of a superframe structure, for a wake-up frame sent by a network controller, where the wake-up frame includes wake-up indication information of a node to be woken up; and

performing data exchange with the network controller when it is determined, according to the wake-up indication information, that a node is the node to be woken up.

With reference to the second aspect, in a first possible implementation manner, the method includes: controlling the node to enter a sleep state when the node is not the node to be woken up.

According to a third aspect, an embodiment of the present invention provides a network controller, including:

a wake-up frame constructing module, configured to construct a wake-up frame, where the wake-up frame includes wake-up indication information of a node to be woken up; and

a wake-up frame sending module, configured to send, in an inactive period of a superframe structure, the wake-up frame according to preset sending time, so that a node that obtains, by listening, the wake-up frame performs data exchange with the network controller when it is determined, according to the wake-up indication information, that the node that obtains, by listening, the wake-up frame is the node to be woken up.

With reference to the third aspect, in a first possible implementation manner, the wake-up indication information is a node address of the node to be woken up or a broadcast wake-up address, and the broadcast wake-up address is indication information used to wake up one type of node or all nodes.

With reference to the third aspect, in a second possible implementation manner, the number of the nodes to be woken up is one or more; and

the number of the wake-up frames is one or more.

With reference to the third aspect, in a third possible implementation manner, the wake-up frame further includes an address of the network controller.

With reference to the third aspect, in a fourth possible implementation manner, the wake-up frame constructing module is specifically configured to construct the wake-up frame according to preset listening time of the node to be woken up.

According to a fourth aspect, an embodiment of the present invention provides a node, including:

a wake-up frame listening module, configured to listen for, at preset listening time in an inactive period of a superframe structure, a wake-up frame sent by a network controller, where the wake-up frame includes wake-up indication information of a node to be woken up; and

a wake-up frame processing module, configured to perform data exchange with the network controller when it is determined, according to the wake-up indication information, that the node is the node to be woken up.

With reference to a fourth aspect, in a first possible implementation manner, the wake-up frame processing module is further configured to control the node to enter a sleep state when the node is not the node to be woken up.

According to a fifth aspect, an embodiment of the present invention provides a network system, including a network controller and a network node wirelessly connected to the network controller. The network controller is the network controller provided in the foregoing embodiment of the present invention, and the network node is the node provided in the foregoing embodiment of the present invention.

According to the node control method, the network controller and the network system provided in the embodiments of the present invention, data communication may be established between a node to be woken up and the network controller by sending a wake-up frame to the node to be woken up in an inactive period of a superframe structure. In this way, a node may also perform data exchange in the inactive period of the superframe structure, so that a length of the superframe structure may be set to be longer to extend a broadcast cycle of a beacon frame, thereby reducing power consumption of nodes in a network caused by frequently parsing the beacon frame, and effectively enhancing a life cycle of an entire wireless sensor network.

### BRIEF DESCRIPTION OF THE DRAWINGS

FIG. 1 is a schematic flowchart of a node control method according to Embodiment 1 of the present invention;

FIG. 2 is a schematic flowchart of a node control method according to Embodiment 2 of the present invention;

FIG. 3 is a schematic diagram of a superframe structure in an embodiment of the present invention;

FIG. 4 is a structural schematic diagram of a node control method according to Embodiment 3 of the present invention;

FIG. 5 is a schematic structural diagram of a network controller according to Embodiment 4 of the present invention;

FIG. 6 is a schematic structural diagram of anode according to Embodiment 5 of the present invention; and

FIG. 7 is a schematic structural diagram of a network system according to Embodiment 6 of the present invention.

### DETAILED DESCRIPTION

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present invention.

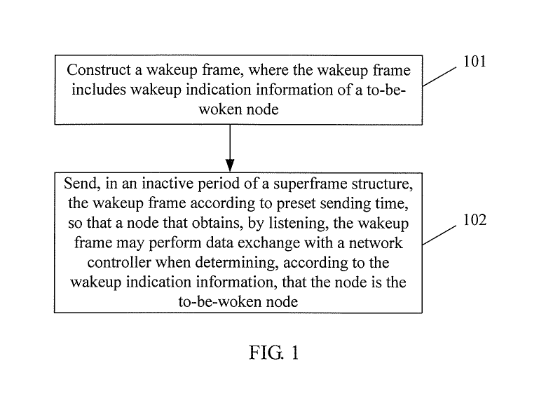

FIG. 1 is a schematic flowchart of a node control method according to Embodiment 1 of the present invention. The node control method in this embodiment is applied to a wireless sensor network. A network controller may construct a wake-up frame, and may send the wake-up frame in an inactive period of a superframe structure, so that a node to be woken up in the network may perform data exchange with the network controller when obtaining, by listening, the wake-up frame. Specifically, as shown in FIG. 1, the method in this embodiment may include the following steps:

Step 101: Construct a wake-up frame, where the wake-up frame includes wake-up indication information of a node to be woken up.

Step 102: Send, in an inactive period of a superframe structure, the wake-up frame according to preset sending time, so that a node that obtains, by listening, the wake-up frame may perform data exchange with a network controller when it is determined, according to the wake-up indication information, that the node that obtains, by listening, the wake-up frame is the node to be woken up.

In this embodiment, the node is a sensor node in the wireless sensor network. The network controller may set preset listening time of the node as the preset sending time to send the wake-up frame. In this way, when the node obtains, by listening, the wake-up frame at the preset listening time, the node determines whether the node is the node to be woken up according to the wake-up indication information of the wake-up frame, so as to perform, when the node is determined as the node to be woken up, data exchange with the network controller to upload data to the network controller or receive data from the network controller. The preset listening time of the node may specifically be listening time, which is set on the node when the node is deployed, for listening for the wake-up frame, or listening time, which is set for the node by the network controller in an active period of the superframe structure after the node is deployed, for listening for the wake-up frame.

A person skilled in the art may understand that the superframe structure includes an active period and an inactive period. The network controller sends a beacon frame in the active period of the superframe structure, so as to synchronize nodes in the network, where a specific implementation of sending the beacon frame is the same as that of sending a beacon frame according to a conventional superframe structure. However, in the inactive period, the network controller may determine, according to a requirement of the network controller, whether to send a wake-up frame, so as to perform data communication with a node to be woken up.

In the node control method according to the embodiment of the present invention, data communication may be established between a node to be woken up and a network controller by sending a wake-up frame to the node to be woken up in an inactive period of a superframe structure. In this way, the node may also perform data exchange in the inactive period of the superframe structure, so that a length of the superframe structure may be set to be longer to extend a broadcast cycle of a beacon frame, thereby reducing power consumption of nodes in a network caused by frequently parsing the beacon frame, and effectively extending a life cycle of an entire wireless sensor network.

In this embodiment, the wake-up indication information in the wake-up frame may specifically be a node address of the node to be woken up or a broadcast wake-up address, and the broadcast wake-up address is indication information used to wake up one type of node or all nodes. In this way, after obtaining, by listening, the wake-up frame, a node may determine whether the node is the node to be woken up based on whether an address of the node is the node address of the node to be woken up in the wake-up frame, or whether the node is a node to be woken up by using the broadcast wake-up address. That the wake-up indication information is the node address of the node to be woken up is used as an example for description in the following.

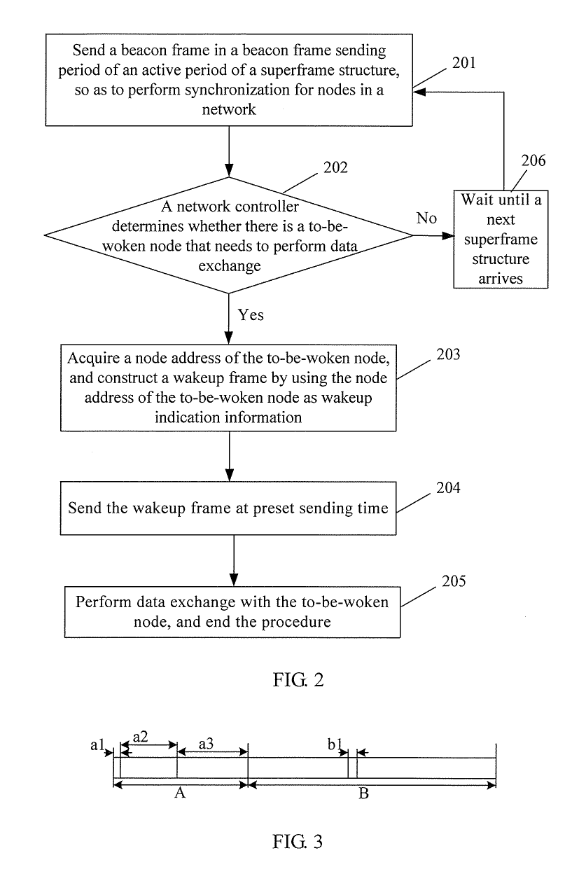

FIG. 2 is a schematic flowchart of a node control method according to Embodiment 2 of the present invention; FIG. 3 is a schematic diagram of a superframe structure in the embodiment of the present invention. As shown in FIG. 2, the method in this embodiment may include the following steps:

Step 201: Send a beacon frame in a beacon frame sending period of an active period of a superframe structure, so as to perform synchronization for nodes in a network.

Step 202: In an inactive period of the superframe structure, a network controller determines whether there is a node to be woken up that needs to perform data exchange; if there is a node to be woken up that needs to perform data exchange, execute step 203; if there is no node to be woken up that needs to perform data exchange, execute step 206.

Step 203: Acquire a node address of the node to be woken up, and construct a wake-up frame by using the node address of the node to be woken up as wake-up indication information.

Step 204: Send the wake-up frame at preset sending time.

Step 205: Perform data exchange with the node to be woken up. The procedure ends.

Step 206: Wait until a next superframe structure arrives, and repeat step 201.

In the foregoing step 201, the beacon frame sent by the network controller in the active period of the superframe structure may include superframe structure information and node synchronization information, such as time synchronization information and frequency synchronization information. In addition, in the active period of the superframe structure, after obtaining, by listening, the beacon frame, nodes in the network may parse the beacon frame and perform synchronization according to content of the beacon frame, and may further perform data exchange with the network controller in the active period. A person skilled in the art may understand that the network controller and the nodes in the network may execute a same or similar function in the active period of the superframe structure in this embodiment, and details are not repeatedly described herein.

In the foregoing step 202, the network controller may determine a node to be woken up according to a requirement. For example, when, according to an instruction of a data management center, data of a node needs to be acquired, the node may be determined as the node to be woken up.

In the foregoing step 203 and step 204, the number of nodes to be woken up may be one or more; the number of constructed wake-up frames may also be one or more. In step 202, when it is determined that there are two or more nodes to be woken up, a wake-up frame may be constructed according to preset listening time of the nodes to be woken up. Specifically, when the preset listening time is inconsistent for the two or more nodes to be woken up, a wake-up frame may be constructed according to the preset listening time by using node addresses of nodes to be woken up that have same preset listening time as the wake-up indication information. In this way, in step 204, a corresponding wake-up frame may be sent when each preset listening time reaches. Or, node addresses of the two or more nodes to be woken up may be constructed in one wake-up frame, and in this way, in step 204, the wake-up frame may be sent in each preset listening time.

In this embodiment, the preset sending time, namely, the preset listening time of the node, may specifically be time that the node needs to listen for the wake-up frame in the inactive period of each superframe length, or the preset sending time may also be listening time of a node lasting for a length of multiple superframes. For example, a network node may perform listening once in a length of two or more superframes. If the network node performs listening once in a length of three superframes, the listening time is listening time in an inactive period of a third superframe after two superframes elapse.

In the foregoing step 205, after the node receives the wake-up frame, if a node address of the node is just the node address in the wake-up frame, the node may determine the node as the node to be woken up, and the node may perform data exchange with the network controller, for example, uploading data.

In this embodiment, the wake-up frame may further include an address of the network controller. In this way, for a network with multiple network controllers, the node may establish data communication with a network controller according to an address of the network controller, that is, a source address.

In this embodiment, FIG. 3 is the schematic diagram of a superframe structure which has a wake-up frame. The superframe structure may include an active period and an inactive period; active period A may include beacon sending period a1, contention access period a2, and contention free period a3; inactive period B further includes wake-up frame sending period b1, where a node to be woken up of a network may listen for a wake-up frame in the wake-up frame sending period. A person skilled in the art may understand that in an actual application, the contention access period and the contention free period in the active period A may be considered as one period, which is used as a period for communication between a node and a network controller, and a specific definition of the active period A is not specially limited in this embodiment.

In this embodiment, a length of a superframe structure, namely, a beacon frame sending cycle may be set to be long enough, and generally may be set to a maximum length, for example, 256 s. A person skilled in the art may understand that a beacon frame refers to information used for synchronizing nodes in a network, and may include information such as a superframe structure.

In this embodiment, preset listening time of a node to be woken up in an inactive period of a superframe structure is time that is set when the node in the network is deployed. The preset listening time may be set according to a requirement, for example, may be a period of two hours, or a period of two days. When the preset listening time of the node to be woken up reaches, the node to be woken up listens for the wake-up frame, so as to determine whether the node to be woken up is the node that the network controller needs to wake up.

In this embodiment, a wake-up frame only needs to include a node address of a node to be woken up; therefore, after a node obtains, by listening, the wake-up frame, the node does not need to parse a great amount of data and consumes less power. In addition, when parsing the wake-up frame and determining that the node is not the node to be woken up indicated by the wake-up frame, the node may immediately enter a sleep state, thereby saving power consumption of the node.

The node control method in this embodiment may be applicable to a wireless sensor network in which some nodes in the network have a special requirement for data uploading. For example, for control over data uploading of nodes with a relatively large difference in the network, not only that centralized uploading data of all the nodes in the network may be implemented in an active period of a superframe structure, single uploading data of some nodes may be also implemented by sending a wake-up frame in an inactive period, so that control over a node is more accurate and energy consumption of a network node is decreased. Specifically, this embodiment may be applicable to a wireless sensor network for wireless meter reading. Generally, a meter reading cycle of a wireless meter reading system has a relatively long interval, for example, once a day, once a week or once a month. In addition, meter reading cycles of nodes in the meter reading system are not completely the same, and some nodes may require a shorter meter reading cycle, for example, some meter reading cycles maybe twice a day or four times a day. In this case, if a length of a superframe structure is set according to a longer meter reading cycle, a node with a shorter meter reading cycle cannot possibly upload data in a timely manner; if the length of the superframe structure is set according to a shorter meter reading cycle, a frequency of sending a beacon frame is relatively large, and consequently, all nodes need to listen to and parse the beacon frame more frequently, which leads to a relatively large energy consumption of the nodes. Therefore, in the technical solution of this embodiment, the superframe structure may be set according to a longer meter reading cycle, and for the nodes with a shorter meter reading cycle, a manner of setting a wake-up frame in the inactive period of the superframe structure may be used to control data uploading of the nodes, which ensures a normal meter reading in the entire meter reading system and also reduces energy consumption of the nodes.

In this embodiment, the superframe structure may specifically comply with a stipulation of the GB/T 15629.15-2010 standard, and a parameter of a superframe structure length may be set to a maximum value; or the shorter time in a delay permitted for data exchange between the node and an exchange cycle for data exchange between the nodes may also be chosen as a length of the superframe structure, so as to ensure normal data exchange between the nodes in the entire network.

In the foregoing embodiment of the present invention, when wake-up indication information in a wake-up frame is a broadcast wake-up address, the broadcast wake-up address may indicate wake-up of one type of node. For example, in a wireless meter reading system, nodes within an area or some special nodes may be considered as one type of node; during node deployment in a network, this type of node may be set as one type and may be identified by using a type identifier. In this case, the broadcast wake-up address may specifically be the type identifier that indicates the nodes that belong to the one type of node. In this way, when a network controller needs to acquire data of the type of node in an inactive period of a superframe structure, the network controller may send a wake-up frame with the broadcast wake-up address, so that the type of node may establish data communication with the network controller according to the wake-up frame.

In this embodiment, when the wake-up indication information in the wake-up frame indicates wake-up of all nodes in the network, the broadcast wake-up address may specifically be an address of the network controller. In this way, after obtaining, by listening, the wake-up frame, the nodes in the network may establish data communication with the network controller, which may be applicable to a network in which nodes need to upload data in a centralized manner, and timely data uploading of the nodes may be ensured when a length of a superframe structure is set to be longer.

In the foregoing embodiments of the present invention, preset listening time for listening for a wake-up frame by nodes may be stored in a network controller, and for nodes to be woken up, only nodes set with preset listening time for listening for a wake-up frame may be used as the nodes to be woken up, and the preset listening time may be used as preset sending time of the wake-up frame.

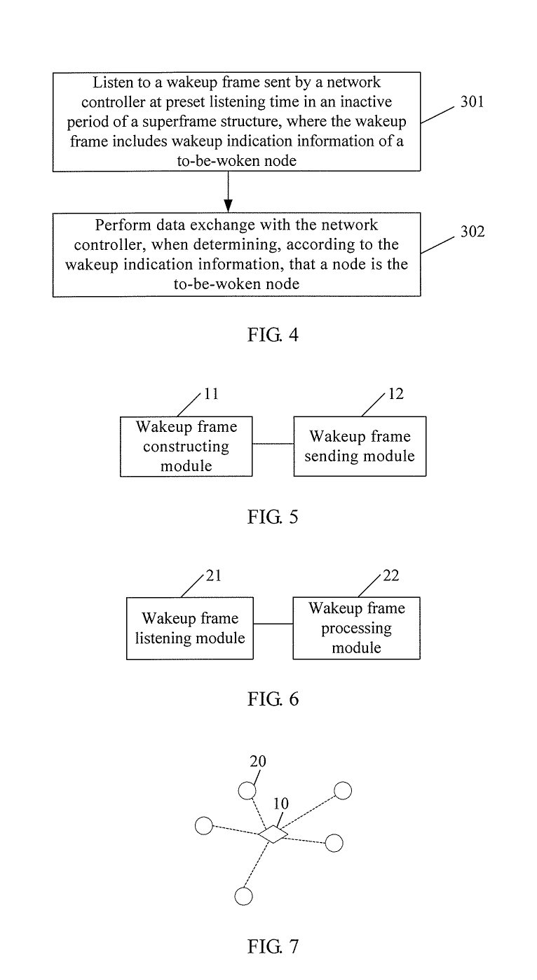

FIG. 4 is a structural schematic diagram of a node control method according to Embodiment 3 of the present invention. An execution body of this embodiment is a network node in a wireless sensor network, and the network node may listen for a wake-up frame sent by a network controller in an inactive period of a superframe structure, so as to implement data exchange with the network controller. Specifically, as shown in FIG. 4, the method in this embodiment may include the following steps:

Step 301: Listen for a wake-up frame sent by a network controller at preset listening time in an inactive period of a superframe structure, where the wake-up frame includes wake-up indication information of a node to be woken up.

Step 302: Perform data exchange with the network controller when it is determined, according to the wake-up indication information, that a node is the node to be woken up.

In this embodiment, the node that obtains, by listening, the wake-up frame may not be a node to be woken up in the wake-up frame sent by the network controller. Therefore, in the foregoing step 302, when the node is not the node to be woken up, the node may be controlled to enter a sleep state, so as to reduce unnecessary power consumption.

This embodiment may be used together with the methods in the foregoing FIG. 1 and FIG. 2 to implement data exchange between a network controller and a network node in a wireless sensor network.

FIG. 5 is a schematic structural diagram of a network controller according to Embodiment 4 of the present invention. As shown in FIG. 5, the network controller in this embodiment includes a wake-up frame constructing module 11 and a wake-up frame sending module 12.

The wake-up frame constructing module 11 is configured to construct a wake-up frame, where the wake-up frame includes wake-up indication information of a node to be woken up.

The wake-up frame sending module 12 is configured to send, in an inactive period of a superframe structure, the wake-up frame according to preset sending time, so that a node that obtains, by listening, the wake-up frame performs data exchange with the network controller when it is determined, according to the wake-up indication information, that the node that obtains, by listening, the wake-up frame is the node to be woken up.

In this embodiment, the wake-up indication information in the wake-up frame may specifically be a node address of the node to be woken up or a broadcast wake-up address, and the broadcast wake-up address is indication information used to wake up one type of node or all nodes.

In this embodiment, the number of nodes to be woken up is one or more; and the number of wake-up frames may also be one or more.

In this embodiment, the wake-up frame further includes an address of the network controller.

In this embodiment, the foregoing wake-up frame constructing module 11 may be specifically configured to construct the wake-up frame according to preset listening time of the node to be woken up.

The network controller in this embodiment may implement functions and steps in the method embodiments shown in the foregoing FIG. 1 or FIG. 2. For specific implementation of the functions and steps, reference may be made to description of the foregoing method embodiments in the present invention, and details are not repeatedly described herein.

FIG. 6 is a schematic structural diagram of a node according to Embodiment 5 of the present invention. As shown in FIG. 6, the node in this embodiment may include a wake-up frame listening module 21 and a wake-up frame processing module 22.

The wake-up frame listening module 21 is configured to listen for, at preset listening time in an inactive period of a superframe structure, a wake-up frame sent by a network controller, where the wake-up frame includes wake-up indication information of a node to be woken up.

The wake-up frame processing module 22 is configured to perform data exchange with the network controller when it is determined, according to the wake-up indication information, that the node is the node to be woken up.

In this embodiment, the foregoing wake-up frame processing module 22 may be further configured to control the node to enter a sleep state when the node is not the node to be woken up.

The node in this embodiment maybe a node in a wireless sensor network in which a network controller shown in the foregoing FIG. 5 is located. The node may listen for a wake-up frame in an inactive period of a superframe structure, so as to implement data exchange with the network controller. For specific implementation thereof, reference may be made to the description of the foregoing method embodiments in the present invention.

FIG. 7 is a schematic structural diagram of a network system according to Embodiment 6 of the present invention. As shown in FIG. 7, the system in this embodiment may include a network controller 10 and a network node 20 in a wireless communication connection with the network controller 10. The network controller 10 may specifically be the network controller shown in the foregoing FIG. 5; there may be multiple network nodes 20, each of which may specifically be the node shown in the foregoing FIG. 6. For a specific structure, reference may be made to the description of the foregoing FIG. 5 or FIG. 6, and details are not repeatedly described herein.

In this embodiment, the network node 20 is specifically a wireless sensor node, and the network node 20 may have a same function with a conventional wireless sensor node, and may include a wireless communication module, a sensor module and a processor module. The sensor module may have an information collection capability and an analog-to-digital conversion capability, and may convert collected information into a digital signal, which is to be processed by the processor module. The wireless communication module may be connected to a wireless communication module of the network controller, so as to perform data exchange with the network controller. Similarly, the network controller 10 may be a gateway node, and the network controller 10 may also include a wireless communication module and a processor module. In addition, the network controller 10 may also be a wireless sensor node, and the network controller 10 may also be used as a gateway node.

A person of ordinary skill in the art may understand that all or a part of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1. A node control method, comprising:
constructing a wake-up frame comprising wake-up indication information of a node to be woken up; and
sending, in an inactive period of a superframe structure, the wake-up frame according to preset sending time, so that a node that obtains, by listening, the wake-up frame performs data exchange with a network controller when it is determined, according to the wake-up indication information, that the node that obtains, by listening, the wake-up frame is the node to be woken up.

2. The node control method according to claim 1, wherein the wake-up indication information comprises:
a node address of the node to be woken up; or
a broadcast wake-up address, and the broadcast wake-up address is indication information used to wake up one type of node or all nodes.

3. The node control method according to claim 1, wherein the number of the nodes to be woken up is one or more.

4. The node control method according to claim 1, wherein the number of the wake-up frames is one or more.

5. The node control method according to claim 1, wherein the wake-up frame comprises an address of the network controller.

6. The node control method according to claim 1, wherein constructing a wake-up frame comprises:
constructing the wake-up frame according to preset listening time of the node to be woken up.

7. A node control method, comprising:
listening, at preset listening time in an inactive period of a superframe structure, for a wake-up frame sent by a network controller, wherein the wake-up frame comprises wake-up indication information of a node to be woken up; and
performing data exchange with the network controller when it is determined, according to the wake-up indication information, that a node is the node to be woken up.

8. The node control method according to claim 7, further comprising:
controlling the node to enter a sleep state when the node is not the node to be woken up.

9. A network controller, comprising:
a wake-up frame constructing module, configured to construct a wake-up frame comprising wake-up indication information of a node to be woken up; and
a wake-up frame sending module, configured to send, in an inactive period of a superframe structure, the wake-up frame according to preset sending time, so that a node that obtains, by listening, the wake-up frame performs data exchange with a network controller when it is determined, according to the wake-up indication information, that the node that obtains, by listening, the wake-up frame is the node to be woken up.

10. The network controller according to claim 9, wherein the wake-up indication information comprises:
a node address of the node to be woken up; or
a broadcast wake-up address, and the broadcast wake-up address is indication information used to wake up one type of node or all nodes.

11. The network controller according to claim 9, wherein:
the number of the nodes to be woken up is one or more; and
the number of the wake-up frames is one or more.

12. The network controller according to claim 9, wherein the wake-up frame comprises an address of the network controller.

13. The network controller according to claim 9, wherein the wake-up frame constructing module is configured to construct a wake-up frame according to preset listening time of the node to be woken up.
